(19) United States
(12) Patent Application Publication
(10) Pub. No.: US 2008/0260964 A1
(43) Pub. Date: Oct. 23, 2008

(54) VISION SYSTEM AND METHOD FOR DIRECT-METAL-DEPOSITION (DMD) TOOL-PATH GENERATION

(76) Inventors: Vijayavel Bagavath-Singh, Rochester Hills, MI (US); Jollin D'Souza, Somers, CT (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/104,992

(22) Filed: Apr. 17, 2008

Related U.S. Application Data
(60) Provisional application No. 60/912,214, filed on Apr. 17, 2007.

(51) Int. Cl. B05D 3/06

(52) U.S. Cl. 427/556

(57) ABSTRACT

New tool paths are automatically created for rapid prototyping and additive manufacturing processes, facilitating the fabrication of new or repaired parts with superior geometries and/or compositional characteristics. The profile of a source part is imaged from camera picture and point wise offset adjustments. Part profile and process points are automatically generated without teaching by an operator. In the preferred embodiment, point-by-point process variable settings (i.e., laser power, speed and powder flow) are coupled to a closed-loop, direct-metal deposition (DMD) process to fabricate or repair production components using a tool path derived from the profile of the source part. The preferred method includes the steps of detecting the edge of the source part; generating a point-to-point database of the source part based upon the detected edge; and assigning one or more process parameters associated with the additive manufacturing process used to fabricate or repair the production part.

### REFERENCE TO RELATED APPLICATION

This application claims priority from U.S. Provisional Patent Application Ser. No. 60/912,214, filed Apr. 17, 2007, the entire content of which is incorporated herein by reference.

### FIELD OF THE INVENTION

This invention relates generally to rapid prototyping and additive manufacturing processes and, in particular, to a system and method whereby new tool paths are automatically created for superior geometries and/or compositional characteristics.

### BACKGROUND OF THE INVENTION

Fabrication of three-dimensional metallic components via layer-by-layer laser cladding was first reported in 1978 by Breinan and Kear. In 1982, U.S. Pat. No. 4,323,756 issued to Brown et al., describes a method for the production of bulk rapidly solidified metallic articles of near-net shape, finding particular utility in the fabrication of certain gas turbine engine components including discs and knife-edge air seals. According to the disclosure, multiple thin layers of feedstock are deposited using an energy beam to fuse each layer onto a substrate. The energy source employed may be a laser or an electron beam. The feedstock employed in the practice of the invention may be either a wire or powder material, and this feedstock is applied to the substrate in such a fashion that it passes through the laser beam and fuses to the melted portion of the substrate.

Different technologies have since evolved to improve such processes. U.S. Pat. No. 4,724,299 is directed to a laser spray nozzle assembly including a nozzle body with a housing that forms an annular passage. The housing has an opening coaxial with a passageway, permitting a laser beam to pass therethrough. A cladding powder supply system is operably associated with the passage for supplying cladding powder thereto so that the powder exits the opening coaxial with the beam.

Various groups are now working world-wide on different types of layered manufacturing techniques for fabrication of near-net-shape metallic components. In particular, nozzles of the type described above have been integrated with multi-axis, commercially available CNC machines for the fabrication of 3-dimensional components. U.S. Pat. No. 5,837,960 resides in a method and apparatus for forming articles from materials in particulate form. The materials are melted by a laser beam and deposited at points along a tool path to form an article of the desired shape and dimensions. Preferably the tool path and other parameters of the deposition process are established using computer-aided design and manufacturing techniques. A controller comprised of a digital computer directs movement of a deposition zone along the tool path and provides control signals to adjust apparatus functions, such as the speed at which a deposition head which delivers the laser beam and powder to the deposition zone moves along the tool path.

Most existing techniques, however, are based on open-loop processes requiring either considerable amount of periodic machining or final machining for close dimensional tolerances. Continuous corrective measures during the manufacturing process are necessary to fabricate net shape functional parts with close tolerances and acceptable residual stress. One exception is the system described in U.S. Pat. No. 6,122,564, filed Jun. 30, 1998. This application, the contents of which are incorporated herein by reference, describes a laser-aided, computer-controlled direct-metal deposition, or DMD, system wherein layers of material are applied to a substrate so as to fabricate an object or to provide a cladding layer.

In contrast to previous methodologies, the DMD system is equipped with feedback monitoring to control the dimensions and overall geometry of the fabricated article in accordance with a computer-aided design (CAD) description. The deposition tool path is generated by a computer-aided manufacturing (CAM) system for CNC machining, with post-processing software for deposition, instead of software for removal as in conventional CNC machining. Initial data using an optical feedback loop indicate that it totally eliminates intermediate machining and reduces final machining considerably. Surface finish on the order of 100 micron has been observed.

Even for closed-loop DMD technology, however, corrective measures are needed to address problematic factors encountered during the process. In particular, the repetitious unloading and loading of parts on a fixture may be an issue since a loaded part's actual position will have slight shift from its CAD tool path expected position. This inaccuracy often leads to machining or other processing problems.

### SUMMARY OF THE INVENTION

This invention resides in a system and method whereby new tool paths are automatically created for rapid prototyping and additive manufacturing processes, facilitating the fabrication of new or repaired parts with superior geometries and/or compositional characteristics.

In broad and general terms, the profile of a source part is imaged from camera picture and point wise offset adjustments. Part profile and process points are automatically generated without teaching by an operator. In the preferred embodiment, point-by-point process variable settings (i.e., laser power, speed and powder flow) are coupled to a closed-loop, direct-metal deposition (DMD) process to fabricate or repair production components using a tool path derived from the profile of the source part. Correction for changes in the orientation of the production parts is accommodated, as is camera picture to automatic NC file generation with point wise process data, also without manual intervention.

An additive manufacturing process according to the invention, comprises the steps of imaging a physical source part, and storing information relating to the source part, including the profile information. A production part to be fabricated or repaired is imaged, and a tool path is automatically generated to fabricate or repair the production part based upon the information relating to the source part. In the pre the additive manufacturing process is a direct-metal deposition (DMD) process. The preferred method includes the steps of detecting the edge of the source part; generating a point-to-point database of the source part based upon the detected edge; and assigning one or more process parameters associated with the additive manufacturing process used to fabricate or repair the production part.

The system and method are particularly valuable in repair and restoration situations where the original CAD geometry and data of the component does not match the component itself after being in service; as one example, in the repair and overhaul of gas turbine blades in the aerospace, defense and power-generation industries.

### BRIEF DESCRIPTION OF THE DRAWINGS

FIG. 1A is a portion of a flow chart the depicts the preferred embodiment of the invention; and

FIG. 1B completes the flow chart of FIG. 1A.

### DETAILED DESCRIPTION OF THE INVENTION

This invention solves problems associated with machining and other processes through the generation of a new tool-path for every production part. To avoid production delays, a highly efficient method is used.

In the preferred embodiment, production cycle time is reduced by automatically generating new tool-paths to accommodate inaccuracies of each part, and to produce high-quality direct-metal deposition (DMD) parts using flexible process controls. The automatic tool-path generation is accomplished using a vision-system-based point and Point Process Property (PPP) database. High-quality deposition is achieved by feeding the vision system PPP to the DMD closed-loop feedback control system.

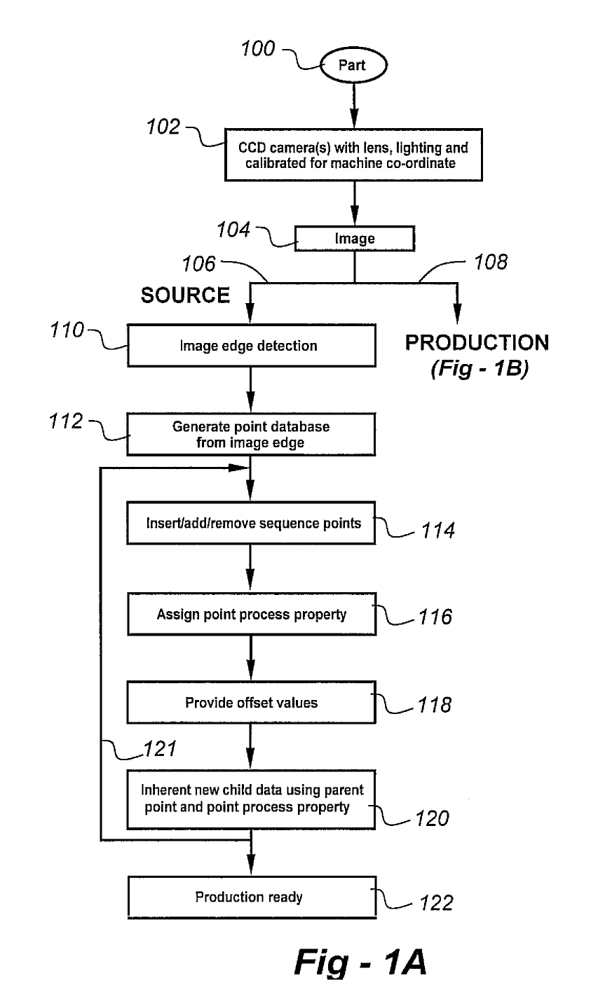

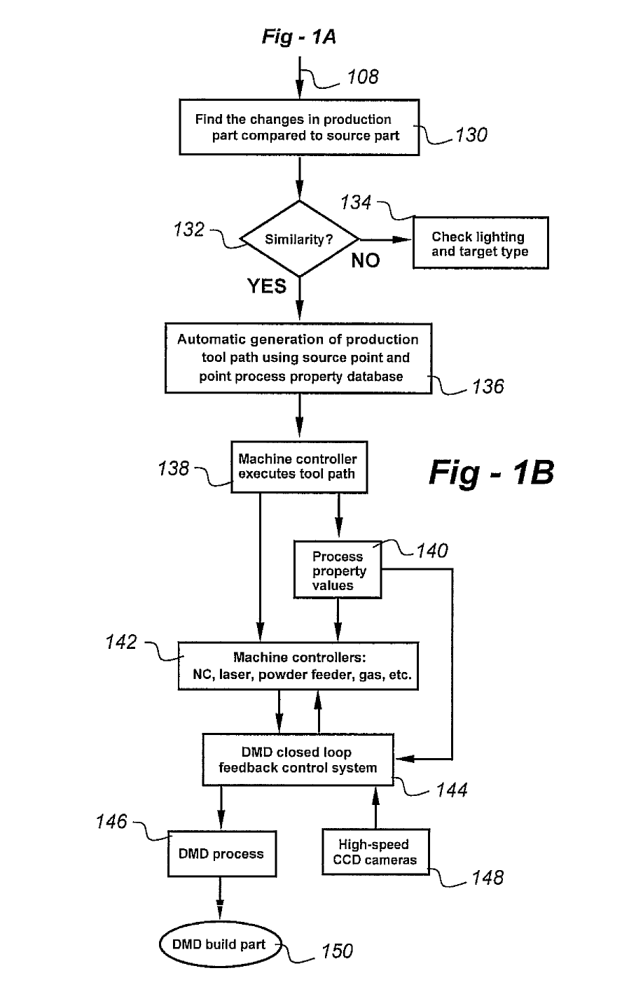

Referring to the flow chart of FIG. 1A, a part is provided at 100, and an image is taken at 104 using a CCD camera at 102. The first part is considered as a source part (106). A machine-coordinated, calibrated camera or cameras image the part and its edges are detected at 110. Based on the edge, the point and PPP database is generated at 112. The user can modify the point and PPP database at 114. The tool-path profile based on the point and PPP database can be traced at 116, and any offset values can be added at 118. The current data can be used to inherit new child data at 120 and modified via feedback loop 121. The part is production ready at 122.

The production flow begins at 108. Again, a machine coordinated, calibrated camera or Cameras image the part, after which the system automatically detects shifts in the production part compared with the source part at 130. Using source data point and PPP database, a new tool-path will be generated based on the new position and new size of the part at 136. If no similarity is determined at 132, a branch is taken to 134 to adjust lighting, target parameters, etc.

The machine controller executes the new tool path at 138. Vision system PPP database values at 142 are feed into the DMD closed-loop feedback control system at 144 which uses real-time NC information and real-time DMD process geometry information at 140 and information from high-speed cameras 148 to control the DMD process with high-processing speed at 142.

The system and method facilitate accurate tool-path generation from visual part imagery with minimal operator intervention. The invention provides an integral tool for enhancing and building on the capabilities of the DMD laser-based process, the intelligent closed-loop thermal management process and visual part manipulation. The system is particularity useful for laser welding and cladding operations where multiple parts are to be processed, and each part has slight variations in geometries due to operational conditions (i.e., turbine blades, blisks).

In conjunction with the DMD process, parameters including laser power, velocity, planar offset and height offset may be altered in accordance with the new tool path. The field-of-view of the camera can also be adjusted with appropriate optics during operation. Part scaling (zoom), translator and rotary displacements are compensated by DMD vision software to provide a robust toolpath for each part. Implementation provides a fine microstructure and better thermal management. A near net shape can be generated using interactions of the DMD process, beam diameter manipulation and the vision system and method described herein.

Multiple vision layers (child layers) can be constructed with ease from the parent layer to extrude a part to a desired height to match the contour and geometry of the part. Once the parameters are established, the invention provides a short cycle time and rapid turnkey operation. Orientation of the part is compensated such that any variations in parts or misplacement of the part on the worktable by the operator or recalling the job after a period of time (6 months, 1 year, etc.). The system may be integrated with commercially available PLC systems.

The system and method are particularly valuable in repair and restoration situations where the original CAD geometry and data of the component does not match the component itself after being in service; as one example, in the repair and overhaul of gas turbine blades in the aerospace, defense and power-generation industries. More specific applications include the restoration of gas turbine blade squealer tips, application of wear resistant cladding in Z-notch welding for (OEM and MRO) and restoration of blisks. The picture on the right shows the restored squeeler tip of and Industrial Turbine blade for the power industry.

We claim:

1. An additive manufacturing process, comprising the steps of:
imaging a physical source part;
storing information relating to the source part, the information including the profile of the source part;
imaging a production part to be fabricated or repaired;
automatically generating a tool path to fabricate or repair the production part based upon the information relating to the source part; and
fabricating or repairing the production part using an additive manufacturing process in accordance with the tool path.

2. The method of claim 1, wherein the additive manufacturing process is a direct-metal deposition (DMD) process.

3. The method of claim 1, including the step of detecting the edge of the source part.

4. The method of claim 1, including the steps of:
detecting the edge of the source part; and
generating a point-to-point database of the source part based upon the detected edge.

5. The method of claim 1, including the steps of:
detecting the edge of the source part;
generating a point-to-point database of the source part based upon the detected edge; and
assigning one or more process parameters associated with the additive manufacturing process used to fabricate or repair the production part.

6. The method of claim 5, wherein the process parameters include numerical control (NC) parameters.

7. The method of claim 5, wherein the process parameters include laser power.

8. The method of claim 5, wherein the process parameters include powder feed.

9. The method of claim 5, wherein the process parameters include gas feed.

10. A part manufactured or repaired in accordance with the process of claim 1.

11. An additive manufacturing process, comprising the steps of:
imaging a physical source part;
storing information relating to the source part, the information including the profile of the source part and process parameters associated with an additive manufacturing process;
imaging a production part to be fabricated or repaired;
automatically generating a tool path to fabricate or repair the production part based upon the profile of the source part and the process parameters; and
fabricating or repairing the production part using the tool path and the process parameters.

12. The method of claim 1, wherein the additive manufacturing process is a direct-metal deposition (DMD) process.

13. The method of claim 1, including the step of detecting the edge of the source part.

14. The method of claim 1, including the steps of:
detecting the edge of the source part; and
generating a point-to-point database of the source part based upon the detected edge.

15. The method of claim 1, including the steps of:
detecting the edge of the source part;
generating a point-to-point database of the source part based upon the detected edge; and
assigning one or more of the process parameters to the point-to-point database.

16. The method of claim 11, wherein the process parameters include numerical control (NC) parameters.

17. The method of claim 11, wherein the process parameters include laser power.

18. The method of claim 11, wherein the process parameters include powder feed.

19. The method of claim 11, wherein the process parameters include gas feed.

20. A part manufactured or repaired in accordance with the process of claim 11.
